(19) United States
(12) Patent Application Publication
(10) Pub. No.: US 2025/0024346 A1
(43) Pub. Date: Jan. 16, 2025

(54) SYSTEMS AND METHODS FOR RECEIVING USER EQUIPMENT ROUTE SELECTION POLICY RULES

(71) Applicant: Verizon Patent and Licensing Inc., Basking Ridge, NJ (US)

(72) Inventors: Lixia YAN, Basking Ridge, NJ (US); Violeta CAKULEV, Milburn, NJ (US); Shanthala KURAVANGI-THAMMAIAH, Keller, TX (US); Lalit R. KOTECHA, San Ramon, CA (US)

(73) Assignee: Verizon Patent and Licensing Inc., Basking Ridge, NJ (US)

(21) Appl. No.: 18/349,607

(22) Filed: Jul. 10, 2023

(51) Int. Cl. H04W 40/02

(52) U.S. Cl. CPC H04W 40/02

(57) ABSTRACT

In some implementations, a user equipment (UE) may receive, from a network node, a UE route selection policy (URSP) that includes one or more URSP rules, wherein a URSP rule, of the one or more URSP rules, indicates one or more of: a radio access technology (RAT) associated with the URSP rule, or one or more public land mobile networks (PLMNs) associated with the URSP rule. The UE may select the URSP rule. The UE may perform traffic routing based on the URSP rule.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE). A UE may communicate with a network node via downlink communications and uplink communications. “Downlink” (or “DL”) refers to a communication link from the network node to the UE, and “uplink” (or “UL”) refers to a communication link from the UE to the network node.

### BRIEF DESCRIPTION OF THE DRAWINGS

FIG. 1 is a diagram of an example associated with a provisioning of a user equipment (UE) route selection policy (URSP).

FIG. 2 is a diagram of an example associated with URSP rules.

FIG. 3 is a diagram of an example associated with receiving URSP rules.

FIG. 4 is a diagram of an example associated with URSP rules.

FIG. 5 is a diagram of an example associated with URSP rules.

FIG. 6 is a diagram of an example environment in which systems and/or methods described herein may be implemented.

FIG. 7 is a diagram of example components of one or more devices of FIG. 6.

FIG. 8 is a flowchart of an example process associated with receiving URSP rules.

### DETAILED DESCRIPTION OF EXAMPLE EMBODIMENTS

The following detailed description of example implementations refers to the accompanying drawings. The same reference numbers in different drawings may identify the same or similar elements.

A user equipment (UE) route selection policy (URSP) may be used to manage network slice information for a UE. The URSP may be a network slice feature that is enabled by a policy and control function (PCF). The PCF may provide, to the UE and via an access and mobility management function (AMF), the URSP, which may inform the UE of a network slice status. The URSP may indicate, to the UE, a mapping of different traffic to different protocol data unit (PDU) sessions and network slices. The UE may be provisioned with the URSP, which may provide information on which PDU session and network slice a given service or application should use when activated. The URSP may be used to dynamically configure a slice selection policy.

The UE may determine a routing of outgoing traffic based on the URSP. The traffic may be routed to an established PDU session based on the URSP. The traffic may be offloaded to a non-Third Generation Partnership Project (non-3GPP) access outside a PDU session based on the URSP. The traffic may be routed via a proximity service (ProSe) layer-3 UE-to-network relay outside a PDU session based on the URSP. The traffic may trigger an establishment of a new PDU session based on the URSP.

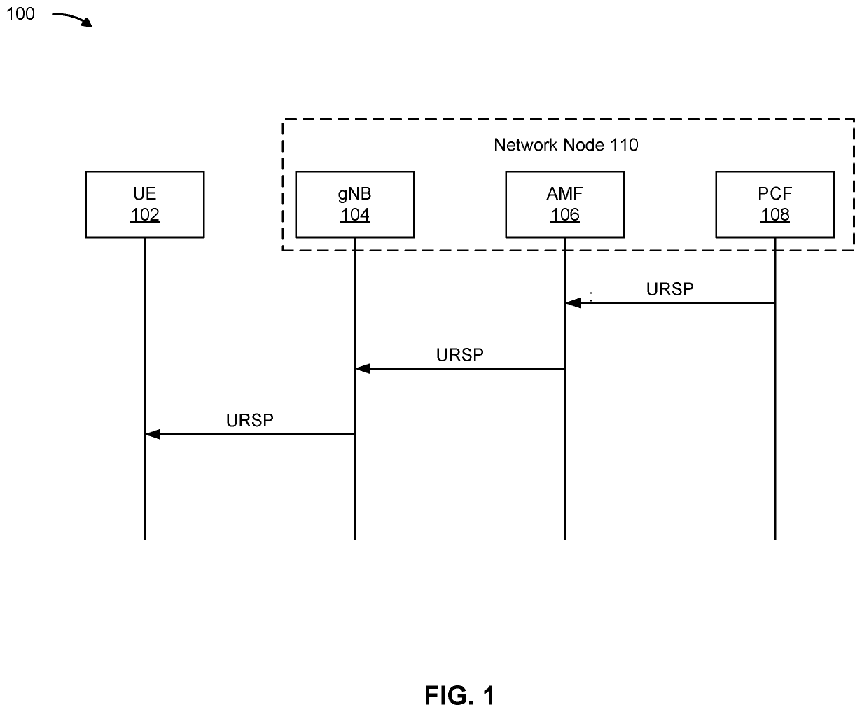

FIG. 1 is a diagram of an example 100 associated with a provisioning of a URSP. During a UE route selection, a network node 110 may transmit, directly or indirectly, the URSP to a UE 102. The network node 110 may be a PCF 108 in a core network, an AMF 106 in the core network, or a gNB 104. For example, the PCF 108 may provision the UE 102 with the URSP, which may include rules related to traffic routing (or data routing). During the UE route selection, the PCF 108 may transmit the URSP to the AMF 106. The AMF 106 may forward the URSP to the gNB 104. The gNB 104 may forward the URSP to the UE 102. The UE 102 may apply the URSP in order to set up a connection or data tunnel. As indicated above, FIG. 1 is provided as an example. Other examples may differ from what is described with regard to FIG. 1.

A URSP may include a set of one or more URSP rules. A URSP rule may include a precedence value of the URSP rule, which may identify a precedence of the URSP rule among a plurality of existing URSP rules.

The URSP rule may include a traffic descriptor. The traffic descriptor may indicate a match-all traffic descriptor. Alternatively, the traffic descriptor may indicate at least one of the following components. For example, the traffic descriptor may indicate one or more application identifiers. The traffic descriptor may indicate an operating system (OS) identifier (ID) and an OS application ID type, an IP version 4 (IPv4) remote address type, an IP version 6 (IPv6) remote address/prefix length type, a protocol identifier/next header type, a single remote port type, and/or a remote port range type. The traffic descriptor may indicate one or more Internet Protocol (IP) 3 tuples (e.g., an IP 3 tuple type, which may include a destination IP address, a destination port number, and a protocol in use above the IP). The traffic descriptor may indicate one or more non-IP descriptors (e.g., destination information of non-IP traffic). The traffic descriptor may indicate a security parameter index type, a type of service/traffic class type, a flow label type, a destination media access control (MAC) address type, and/or an Ethernet type. The traffic descriptor may indicate one or more domain name systems (DNNs) (e.g., a DNN type). The traffic descriptor may indicate one or more connection capabilities. The traffic descriptor may indicate one or more domain descriptors, e.g., destination fully qualified domain name(s) (FQDN(s)) or a regular expression as a domain name matching criteria.

The URSP rule may include one or more route selection descriptors. A route selection descriptor, of the one or more route selection descriptors, may indicate a precedence value of the route selection descriptor, and either one PDU session type, a non-seamless non-3GPP offload indication, or a Fifth Generation (5G) ProSe layer-3 UE-to-network relay offload indication. The route selection descriptor may indicate the one PDU session type and, optionally, one or more of the following components. For example, the route selection descriptor may indicate a session and service continuity (SSC) mode (e.g., an SSC mode type). The route selection descriptor may indicate one or more single network slice selection assistance informations (S-NSSAIs) (e.g., an S-NSSAI type). The route selection descriptor may indicate one or more DNNs (e.g., a DNN type). The route selection descriptor may indicate a preferred access type. The route selection descriptor may indicate a multi-access preference type. The route selection descriptor may indicate a time window. The route selection descriptor may indicate location criteria. The route selection descriptor may indicate a PDU session pair ID. The route selection descriptor may indicate a redundancy sequence number (RSN).

A core network may provision URSP rules to a UE, which may provide instructions to the UE on which PDU session or network slice should be used transmit a given service or application. The URSP rules may include traffic descriptors and route selection descriptors. The UE may evaluate the URSP rules with a traffic descriptor matching application information in an increasing order of precedence values. The UE may determine which URSP rule supports specific traffic based on the traffic descriptor. The UE may evaluate the URSP rules based on an upper layer requesting information of the PDU session via which to transmit a PDU of the application. During a URSP rules evaluation, the UE may identify the traffic descriptor in the URSP rule matching the application information, and an established PDU session matching at least one of the route selection descriptors of the URSP rule. When there is no suitable existing PDU session, the UE may establish a PDU session for one of the route selection descriptors. The URSP may be provisioned to the UE when the UE is operating in a 5G network, but the URSP may be applicable and effective while the UE is operating in a Fourth Generation (4G) network or in the 5G network.

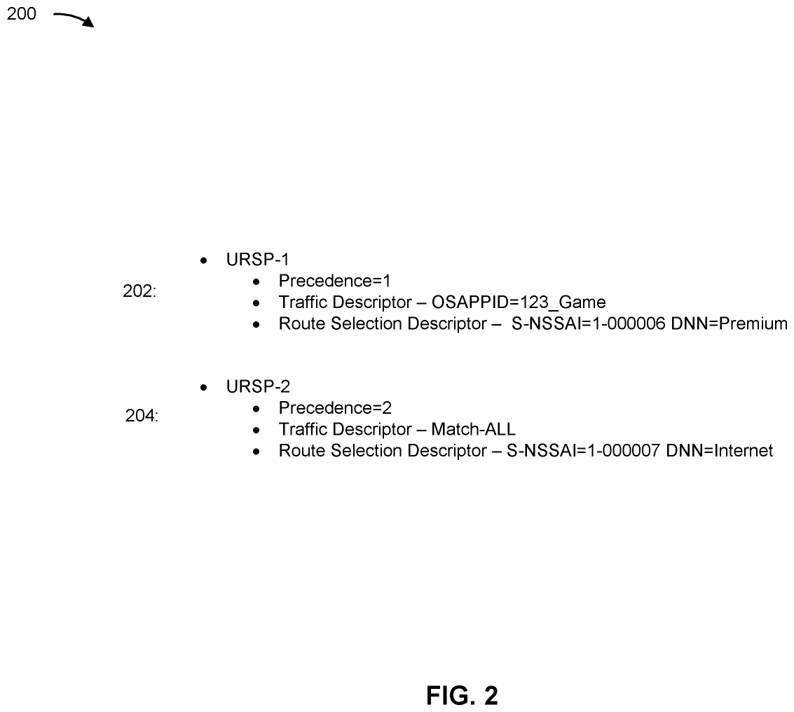

FIG. 2 is a diagram of an example 200 associated with URSP rules. As shown by reference number 202, a first URSP rule (URSP-1) may be associated with a first precedence value (e.g., precedence=1), a first traffic descriptor (e.g., an OS application ID of a gaming application), and a first route selection descriptor. The first route selection descriptor may indicate an S-NSSAI (e.g., S-NSSAI=1-000006) and a DNN (e.g., DNN=Premium). As shown by reference number 204, a second URSP rule (URSP-2) may be associated with a second precedence value (e.g., precedence=2), a second traffic descriptor (e.g., match all), and a second route selection descriptor. The second route selection descriptor may indicate an S-NSSAI (e.g., S-NSSAI=1-000007) and a DNN (e.g., DNN=Internet). As indicated above, FIG. 2 is provided as an example. Other examples may differ from what is described with regard to FIG. 2.

A UE may operate in a 5G New Radio (NR) network. The 5G NR network may be associated with a first radio access technology (RAT) (e.g., NR). The UE may apply a URSP rule when operating in the 5G NR network, where the URSP rule may be provisioned by a PCF. In some cases, based on a mobility of the UE, the UE may connect to a 4G Long Term Evolution (LTE) network. The 4G LTE network may be associated with a second RAT (e.g., LTE). However, the URSP rule may not be applicable to the 4G LTE network. The UE may attempt to apply the URSP rule, but the URSP rule may no longer be valid at the UE because the UE is now operating in the 4G LTE network. An inability to apply the URSP rule provisioned by the PCF may degrade a performance of the UE.

Further, the UE may operate in a first public land mobile network (PLMN). The UE may apply the URSP rule when operating in the first PLMN. Based on the mobility of the UE, the UE may connect to a second PLMN. The UE may automatically apply the URSP rule in the second PLMN. However, applying the URSP rule in the second PLMN may not be desirable. For example, applying the URSP rule in the second PLMN, as opposed to the first PLMN, may degrade the performance of the UE and/or increase costs associated with using the UE.

In some implementations described herein, a UE may receive, from a network node, a URSP that includes one or more URSP rules. A URSP rule, of the one or more URSP rules, may indicate a RAT (e.g., 4G LTE) associated with the URSP rule. For example, the URSP rule may only be applicable to 4G LTE. The URSP rule may indicate one or more PLMNs associated with the URSP rule. The URSP rule may only be applicable to the one or more PLMNs. The URSP rule may not be applicable to PLMNs that are not included in the one or more PLMNs. The UE may support use cases in which the URSP rule is only applicable to 4G LTE and/or the URSP rule is only applicable to a list of PLMNs, which may be based on the URSP received from the network node. The UE may select the URSP rule, or alternatively, the UE may select a different URSP rule from the one or more URSP rules. The UE may perform a traffic routing based on a selected URSP rule.

In some implementations, based on a mobility of the UE, the UE may move from a 5G NR network to a 4G LTE network. In this case, the UE may apply the URSP rule that is only applicable to the 4G LTE network. The UE may not be forced to use a URSP rule that is associated with the 5G NR network, and which may not be suitable with the 4G LTE network. Since the UE may use the URSP rule that is dedicated to the 4G LTE network, a performance of the UE may be improved. In some implementations, based on the mobility of the UE, the UE may move from a first PLMN to a second PLMN. Rather than automatically applying an existing URSP rule, the UE may apply a URSP rule that is applicable to the second PLMN, which may be on the list of PLMNs that are supported for the URSP rule. The UE may not apply a URSP rule that is not applicable to the second PLMN. By applying the URSP rule that is applicable to the second PLMN, the UE may avoid a performance degradation and/or increased costs associated with using the UE. In some implementations, by indicating the RAT and/or the one or more PLMNs in the URSP rule, the UE may be enabled to select appropriate URSP rules when certain conditions are met (e.g., the UE moves to the 4G LTE network, or the UE moves to another PLMN), which may improve the performance of the UE.

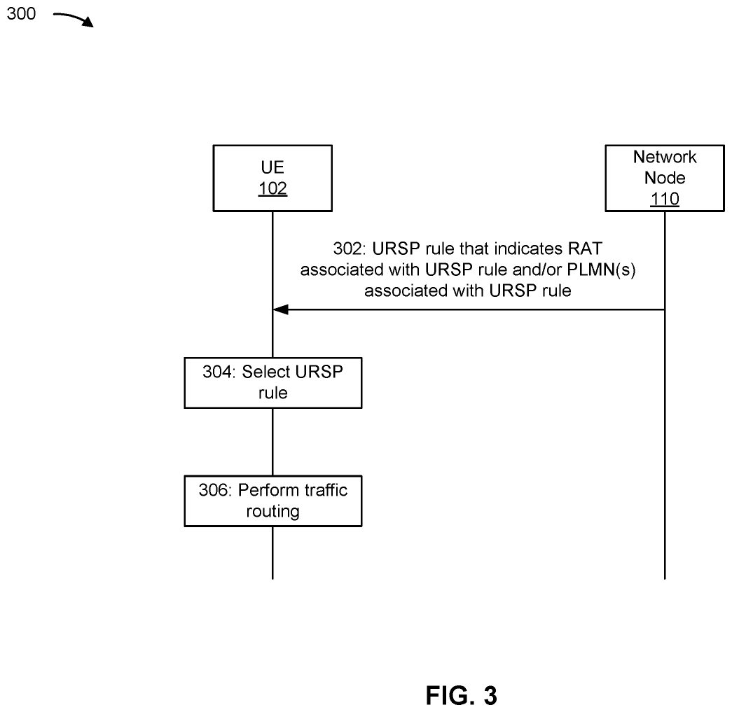

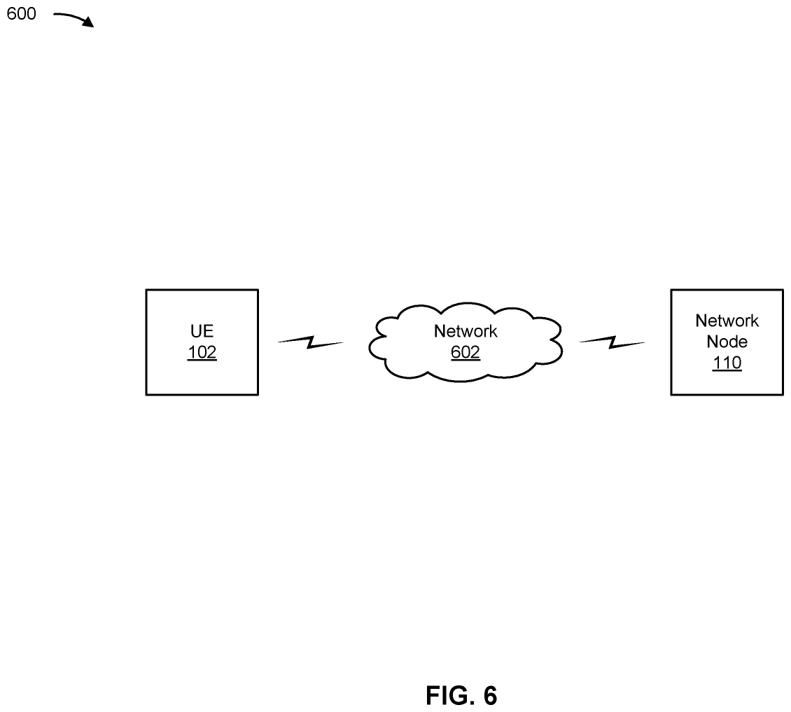

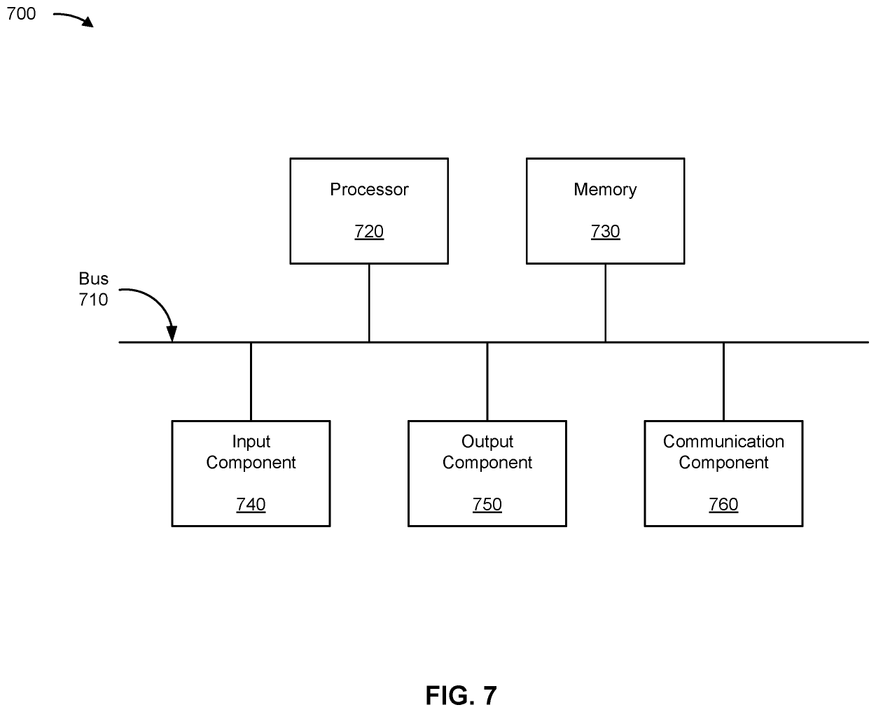

FIG. 3 is a diagram of an example implementation 300 associated with systems and methods for receiving URSP rules. As shown in FIG. 3, example implementation 300 includes a UE 102 and a network node 110 (e.g., a gNB 104, an AMF 106, or a PCF 108). These devices are described in more detail below in connection with FIG. 6 and FIG. 7.

As shown by reference number 302, the UE 102 may receive, from the network node 110, a URSP that includes one or more URSP rules. The UE 102 may receive the URSP during a provisioning of the URSP. A URSP rule, of the one or more URSP rules, may include a traffic descriptor and a route selection descriptor. For example, each URSP rule associated with the URSP may include the traffic descriptor and the route selection descriptor. In some implementations, the traffic descriptor and/or the route selection descriptor may indicate a RAT associated with the URSP rule. In other words, the traffic descriptor and/or the route selection descriptor may include a RAT-type ID, which may indicate the RAT that is associated with the URSP rule. The URSP rule may only be applicable to the RAT indicated by the URSP rule. For example, the RAT may be a first RAT (e.g., 4G LTE RAT), a second RAT (e.g., 5G NR RAT), a third RAT (e.g., 6G), and so on. As a result, some URSP rules may only be applicable to 4G LTE and may not be applicable to 5G NR. In some implementations, the traffic descriptor and/or the route selection descriptor may indicate one or more PLMNs (or a list of PLMNs) associated with the URSP rule. A PLMN may be indicated by a mobile country code (MCC) (e.g., MCC=12345*). The URSP rule may only be applicable to the one or more PLMNs. For a PLMN that is not included in the one or more PLMNs, a different URSP rule may be applied. The traffic descriptor and/or the route selection descriptor may support a PLMN list and a PLMN wildcard match, which may indicate PLMN(s) that are associated with the URSP rule. The PLMN wildcard match may involve identifying a URSP rule associated with a PLMN that matches a PLMN associated with the UE 102. For example, a first URSP rule may be associated with an MCC that begins with “123”, whereas a second URSP rule may be associated with MCCs that do not begin with “123”. As a result, some URSP rules may only be applicable to the list of PLMNs.

In some implementations, the URSP rule may only include the RAT-type ID and may not indicate the PLMN. In some implementations, the URSP rule may only indicate the PLMN and may not include the RAT-type ID. In some implementations, the URSP rule may include the RAT-type ID, as well as indicate the PLMN.

As shown by reference number 304, the UE 102 may select the URSP rule. The UE 102 may select the URSP rule during a URSP rules evaluation. The UE 102 may select the URSP rule from the one or more URSP rules associated with the URSP. In some implementations, the UE 102 may select the URSP rule based on a RAT associated with the UE corresponding to the RAT associated with the URSP rule. For example, when the UE 102 is associated with the 5G NR RAT, the UE 102 may select the URSP rule that is associated with the 5G NR RAT (e.g., based on a RAT-type information element (IE) associated with the URSP rule). When the UE 102 is associated with the 4G LTE RAT, the UE 102 may select the URSP rule that is associated with the 4G LTE RAT. In some implementations, the UE 102 may select the URSP rule based on a PLMN associated with the UE 102 corresponding to the one or more PLMNs associated with the URSP rule. The UE 102 may select a different URSP rule based on the PLMN associated with the UE not corresponding to the one or more PLMNs associated with the URSP rule. For example, when the UE 102 is associated with a first PLMN (e.g., a home network), the UE 102 may select the URSP rule that is associated with the first PLMN (e.g., based on the supported PLMN list and the PLMN wildcard match). When the UE 102 is associated with a second PLMN (e.g., a roaming network), the UE 102 may select the different URSP rule that is associated with the second PLMN.

As shown by reference number 306, the UE 102 may perform traffic routing based on the URSP rule. The UE 102 may utilize an existing PDU session based on the URSP rule. The UE 102 may route traffic to the existing PDU session based on the URSP rule. Alternatively, the UE 102 may establish a new PDU session based on the URSP rule. The UE 102 may route traffic to the new PDU session based on the URSP rule.

In some implementations, based on a mobility of the UE 102, the UE 102 may move from a 5G NR network to a 4G LTE network. In this case, the UE 102 may apply the URSP rule that is only applicable to the 4G LTE network. The UE 102 may not be forced to use a URSP rule that is associated with the 5G NR network, and which may not be suitable with the 4G LTE network. Since the UE 102 may use the URSP rule that is dedicated to the 4G LTE network, a performance of the UE 102 may be improved. In some implementations, based on the mobility of the UE 102, the UE 102 may move from the first PLMN to the second PLMN. The first PLMN may be associated with the home network. The second PLMN may be associated with the roaming network. Rather than automatically applying an existing URSP rule, the UE 102 may apply a URSP rule that is applicable to the second PLMN, which may be on the list of PLMNs that are supported for the URSP rule. The UE 102 may not apply a URSP rule that is not applicable to the second PLMN. By applying the URSP rule that is applicable to the second PLMN, the UE 102 may avoid a performance degradation and/or increased costs. In some implementations, by indicating the RAT and/or the one or more PLMNs in the URSP rule during the provisioning of the URSP, the UE 102 may be enabled to select appropriate URSP rules when certain conditions are met (e.g., the UE 102 moves to the 4G LTE network, or the UE 102 moves to another PLMN), which may improve the performance of the UE 102.

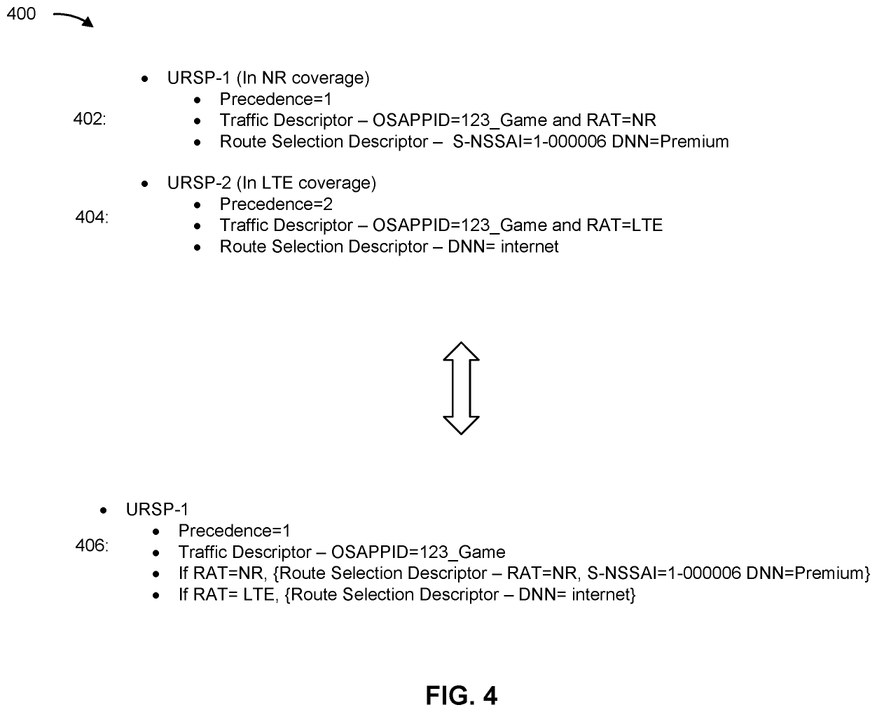

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3. FIG. 4 is a diagram of an example 400 associated with URSP rules.

As shown by reference number 402, a first URSP rule (e.g., URSP-1) may be associated with a 5G NR coverage. The first URSP rule may be associated with a first precedence (e.g., precedence=1). The first URSP rule may be associated with a first traffic descriptor. The first traffic descriptor may indicate an OS application ID (e.g., OSAPPID=123_Game) and a RAT-Type IE (e.g., RAT=NR). The first URSP rule may indicate a first route selection descriptor. The first route selection descriptor may indicate an S-NSSAI (e.g., S-NSSAI=1-000006) and a DNN (e.g., DNN=Premium).

As shown by reference number 404, a second URSP rule (e.g., URSP-2) may be associated with a 4G LTE coverage. The second URSP rule may be associated with a second precedence (e.g., precedence=2). The second URSP rule may be associated with a second traffic descriptor. The second traffic descriptor may indicate an OS application ID (e.g., OSAPPID=123_Game) and a RAT-Type IE (e.g., RAT=LTE). The second URSP rule may indicate a second route selection descriptor. The second route selection descriptor may indicate a DNN (e.g., DNN=internet).

As shown by reference number 406, when a UE is associated with a 5G NR RAT, the UE may apply the first URSP rule, which may be associated with, for example, S-NSSAI=1-000006 and DNN=Premium. When the UE is associated with a 4G NR RAT, the UE may apply the second URSP rule, which may be associated with, for example, DNN=internet. The second URSP rule may only be applicable to a 4G LTE network, and may not be applicable when the UE is in a 5G NR network.

In some implementations, the UE may be in the 5G NR network. The UE may first evaluate the first URSP rule. The UE may determine that the first URSP rule is applicable to the UE. Alternatively, the UE may be in the 4G LTE network. The UE may first evaluate the first URSP rule. The UE may determine that the first URSP rule is not applicable to the UE. The UE may next evaluate the second URSP rule. The UE may determine that the second URSP rule is applicable to the UE. The second URSP rule may only be applicable to the 4G LTE network.

As indicated above, FIG. 4 is provided as an example. Other examples may differ from what is described with regard to FIG. 4.

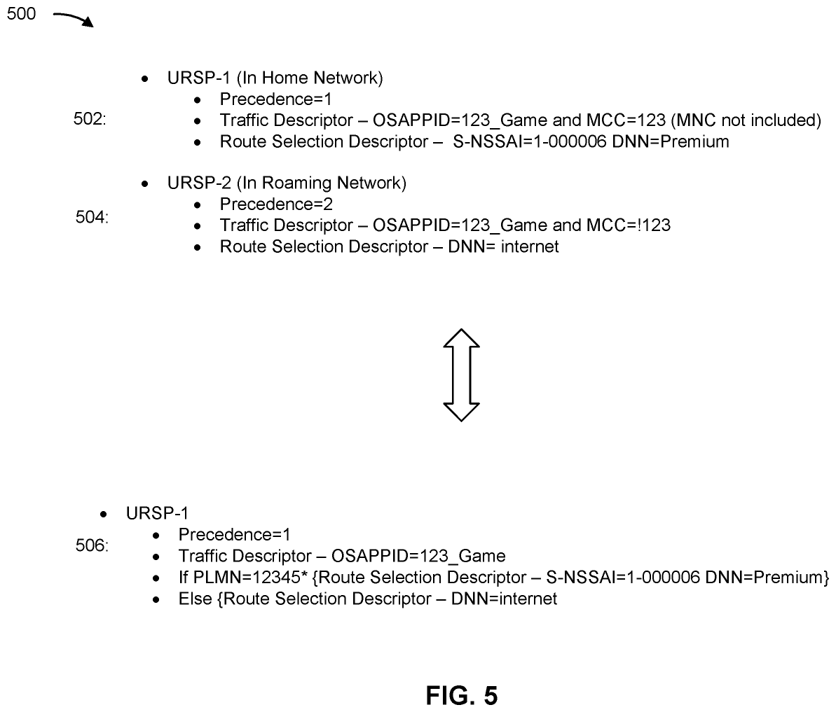

FIG. 5 is a diagram of an example 500 associated with URSP rules.

As shown by reference number 502, a first URSP rule (e.g., URSP-1) may be associated with a home network. The home network may be associated with a first PLMN. The first URSP rule may be associated with a first precedence (e.g., precedence=1). The first URSP rule may be associated with a first traffic descriptor. The first traffic descriptor may indicate an OS application ID (e.g., OSAPPID=123_Game) and an MCC (e.g., MCC=311). In this case, the first traffic descriptor may be associated with an MCC that begins with “311”. The first traffic descriptor may not include a mobile network code (MNC). The first URSP rule may indicate a first route selection descriptor. The first route selection descriptor may indicate an S-NSSAI (e.g., S-NSSAI=1-000006) and a DNN (e.g., DNN=Premium).

As shown by reference number 504, a second URSP rule (e.g., URSP-2) may be associated with a roaming network. The roaming network may be associated with a second PLMN. The second URSP rule may be associated with a second precedence (e.g., precedence=2). The second URSP rule may be associated with a second traffic descriptor. The second traffic descriptor may indicate an OS application ID (e.g., OSAPPID=123_Game) and an MCC (e.g., MCC=!311). In this case, the second traffic descriptor may be associated with an MCC that does not begin with “311”. The second URSP rule may indicate a second route selection descriptor. The second route selection descriptor may indicate a DNN (e.g., DNN=internet).

As shown by reference number 506, when a UE is associated with a PLMN that starts with “311” (e.g., the first PLMN), the UE may apply the first URSP rule, which may be associated with, for example, S-NSSAI=1-000006 and DNN=Premium. When the UE is associated with a PLMN that does not start with “311” (e.g., the second PLMN), the UE may apply the second URSP rule, which may be associated with, for example, DNN=internet. The first URSP rule and the second URSP rule may only be applicable to a certain PLMN, respectively, and may not be applicable for other PLMNs, respectively.

In some implementations, the UE may be in the first PLMN. The UE may first evaluate the first URSP rule. The UE may determine that the first URSP rule is applicable to the UE. Alternatively, the UE may be in the second PLMN. The UE may first evaluate the first URSP rule. The UE may determine that the first URSP rule is not applicable to the UE. The UE may next evaluate the second URSP rule. The UE may determine that the second URSP rule is applicable to the UE. The second URSP rule may only be applicable to the second PLMN.

As indicated above, FIG. 5 is provided as an example. Other examples may differ from what is described with regard to FIG. 5.

FIG. 6 is a diagram of an example environment 600 in which systems and/or methods described herein may be implemented. As shown in FIG. 6, environment 600 may include a UE 102, a network node 110, and a network 602. Devices of environment 600 may interconnect via wired connections, wireless connections, or a combination of wired and wireless connections.

The UE 102 may include one or more devices capable of receiving, generating, storing, processing, and/or providing information associated with receiving URSP rules, as described elsewhere herein. The UE 102 may include a communication device and/or a computing device. For example, the UE 102 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network node 110 may include one or more devices capable of receiving, processing, storing, routing, and/or providing information associated with receiving URSP rules, as described elsewhere herein. The network node 110 may be configured to communicate, directly or indirectly, with the UE 102. The network node 110 may include a gNB (e.g., gNB 104), an AMF (e.g., 106), or a PCF (e.g., 108). The network node 110 may be an aggregated network node, meaning that the aggregated network node is configured to utilize a radio protocol stack that is physically or logically integrated within a single radio access network (RAN) node (e.g., within a single device or unit). The network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)). The network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node (e.g., the AMF or the PCF), a network element, a network equipment, and/or a RAN node.

The network 602 may include one or more wired and/or wireless networks. For example, the network 602 may include a cellular network (e.g., a sixth generation (6G) network, a 5G network, a 4G network, an LTE network, a third generation (3G) network, a code division multiple access (CDMA) network, etc.), a PLMN, a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 602 enables communication among the devices of environment 600.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

FIG. 7 is a diagram of example components of a device 700 associated with receiving URSP rules. The device 700 may correspond to UE 102 and/or network node 110. In some implementations, UE 102 and/or network node 110 may include one or more devices 700 and/or one or more components of the device 700. As shown in FIG. 7, the device 700 may include a bus 710, a processor 720, a memory 730, an input component 740, an output component 750, and/or a communication component 760.

The bus 710 may include one or more components that enable wired and/or wireless communication among the components of the device 700. The bus 710 may couple together two or more components of FIG. 7, such as via operative coupling, communicative coupling, electronic coupling, and/or electric coupling. For example, the bus 710 may include an electrical connection (e.g., a wire, a trace, and/or a lead) and/or a wireless bus. The processor 720 may include a central processing unit, a graphics processing unit, a microprocessor, a controller, a microcontroller, a digital signal processor, a field-programmable gate array, an application-specific integrated circuit, and/or another type of processing component. The processor 720 may be implemented in hardware, firmware, or a combination of hardware and software. In some implementations, the processor 720 may include one or more processors capable of being programmed to perform one or more operations or processes described elsewhere herein.

The memory 730 may include volatile and/or nonvolatile memory. For example, the memory 730 may include random access memory (RAM), read only memory (ROM), a hard disk drive, and/or another type of memory (e.g., a flash memory, a magnetic memory, and/or an optical memory). The memory 730 may include internal memory (e.g., RAM, ROM, or a hard disk drive) and/or removable memory (e.g., removable via a universal serial bus connection). The memory 730 may be a non-transitory computer-readable medium. The memory 730 may store information, one or more instructions, and/or software (e.g., one or more software applications) related to the operation of the device 700. In some implementations, the memory 730 may include one or more memories that are coupled (e.g., communicatively coupled) to one or more processors (e.g., processor 720), such as via the bus 710. Communicative coupling between a processor 720 and a memory 730 may enable the processor 720 to read and/or process information stored in the memory 730 and/or to store information in the memory 730.

The input component 740 may enable the device 700 to receive input, such as user input and/or sensed input. For example, the input component 740 may include a touch screen, a keyboard, a keypad, a mouse, a button, a microphone, a switch, a sensor, a global positioning system sensor, an accelerometer, a gyroscope, and/or an actuator. The output component 750 may enable the device 700 to provide output, such as via a display, a speaker, and/or a light- emitting diode. The communication component 760 may enable the device 700 to communicate with other devices via a wired connection and/or a wireless connection. For example, the communication component 760 may include a receiver, a transmitter, a transceiver, a modem, a network interface card, and/or an antenna.

The device 700 may perform one or more operations or processes described herein. For example, a non-transitory computer-readable medium (e.g., memory 730) may store a set of instructions (e.g., one or more instructions or code) for execution by the processor 720. The processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry may be used instead of or in combination with the instructions to perform one or more operations or processes described herein. Additionally, or alternatively, the processor 720 may be configured to perform one or more operations or processes described herein. Thus, implementations described herein are not limited to any specific combination of hardware circuitry and software.

The number and arrangement of components shown in FIG. 7 are provided as an example. The device 700 may include additional components, fewer components, different components, or differently arranged components than those shown in FIG. 7. Additionally, or alternatively, a set of components (e.g., one or more components) of the device 700 may perform one or more functions described as being performed by another set of components of the device 700.

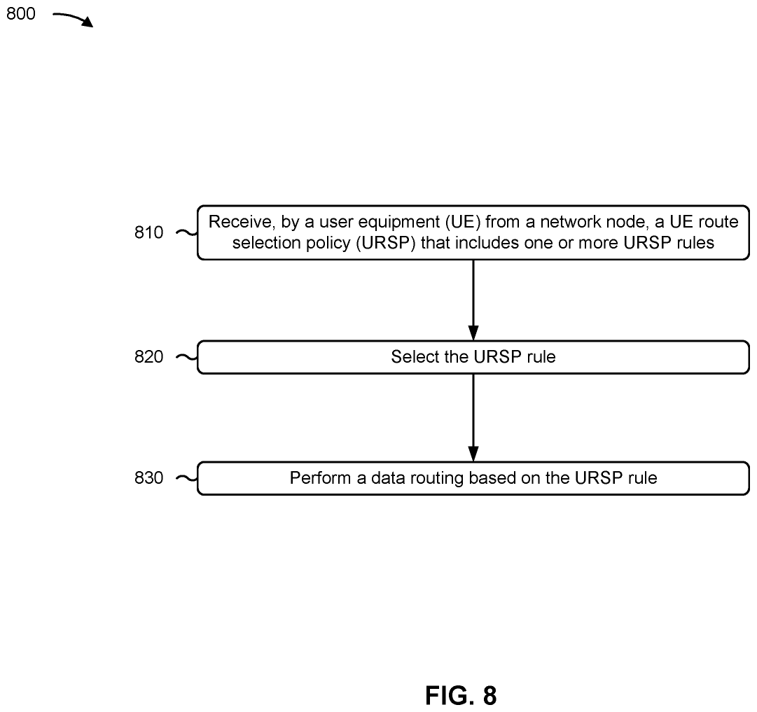

FIG. 8 is a flowchart of an example process 800 associated with receiving URSP rules. In some implementations, one or more process blocks of FIG. 8 may be performed by a UE (e.g., UE 102). In some implementations, one or more process blocks of FIG. 8 may be performed by another device or a group of devices separate from or including the UE, such as a network node (e.g., network node 110). Additionally, or alternatively, one or more process blocks of FIG. 8 may be performed by one or more components of device 700, such as processor 720, memory 730, input component 740, output component 750, and/or communication component 760.

As shown in FIG. 8, process 800 may include receiving, by the UE and from the network node, a URSP that includes one or more URSP rules (block 810). A URSP rule, of the one or more URSP rules, may indicate a RAT associated with the URSP rule. The URSP rule may only be applicable to the RAT. The RAT may be a 4G LTE RAT. The URSP rule may not be applicable to other RATs (e.g., a 5G NR RAT). Additionally, or alternatively, the URSP rule may indicate one or more PLMNs associated with the URSP rule. The URSP rule may only be applicable to the one or more PLMNs. The URSP rule may not be applicable to PLMNs that are not included in the one or more PLMNs. The URSP rule may include a traffic descriptor and a route selection descriptor. The RAT may be indicated in the traffic descriptor and/or the route selection descriptor. The one or more PLMNs may be indicated in the traffic descriptor and/or the route selection descriptor.

As further shown in FIG. 8, process 800 may include selecting, by the UE, the URSP rule (block 820). The UE may select the URSP rule from the URSP received from the network node. The UE may select the URSP rule based on a RAT associated with the UE (e.g., 4G LTE) corresponding to the RAT associated with the URSP rule. Additionally, or alternatively, the UE may select the URSP rule based on a PLMN associated with the UE (e.g., a PLMN associated with a home network) corresponding to the one or more PLMNs associated with the URSP rule. The UE may select a different rule based on a PLMN associated with the UE (e.g., a PLMN associated with a roaming network) not corresponding to the one or more PLMNs associated with the URSP rule.

As further shown in FIG. 8, process 800 may include performing, by the UE, a traffic routing based on the URSP rule selected by the UE (block 830). The UE may utilize an existing PDU session based on the URSP rule. The UE may route traffic to the existing PDU session based on the URSP rule. Alternatively, the UE may establish a new PDU session based on the URSP rule. The UE may route traffic to the new PDU session based on the URSP rule.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a user equipment (UE) from a network node, a UE route selection policy (URSP) that includes one or more URSP rules, wherein a URSP rule, of the one or more URSP rules, indicates one or more of:
a radio access technology (RAT) associated with the URSP rule, or
one or more public land mobile networks (PLMNs) associated with the URSP rule;
selecting, by the UE, the URSP rule; and
performing, by the UE, traffic routing based on the URSP rule.

2. The method of claim 1, wherein the URSP rule is only applicable to the RAT, and the RAT is a Fourth Generation (4G) Long Term Evolution (LTE) RAT.

3. The method of claim 1, wherein the URSP rule is only applicable to the one or more PLMNs.

4. The method of claim 1, wherein the URSP rule includes a traffic descriptor and a route selection descriptor, and the RAT is indicated in one or more of the traffic descriptor or the route selection descriptor.

5. The method of claim 1, wherein the URSP rule includes a traffic descriptor and a route selection descriptor, and the one or more PLMNs are indicated in one or more of the traffic descriptor or the route selection descriptor.

6. The method of claim 1, wherein selecting the URSP rule comprises selecting, by the UE, the URSP rule based on a RAT associated with the UE corresponding to the RAT associated with the URSP rule.

7. The method of claim 1, wherein selecting the URSP rule comprises selecting, by the UE, the URSP rule based on a PLMN associated with the UE corresponding to the one or more PLMNs associated with the URSP rule.

8. The method of claim 1, further comprising:
selecting, by the UE, a different URSP rule based on a PLMN associated with the UE not corresponding to the one or more PLMNs associated with the URSP rule.

9. A user device, comprising:
one or more processors configured to:
receive, from a network node, a user equipment (UE) route selection policy (URSP) that includes one or more URSP rules, wherein a URSP rule, of the one or more URSP rules, indicates one or more of:
a radio access technology (RAT) associated with the URSP rule, or
one or more public land mobile networks (PLMNs) associated with the URSP rule;
select the URSP rule; and
perform a traffic routing based on the URSP rule.

10. The user device of claim 9, wherein the URSP rule is only applicable to the RAT, and the RAT is a Fourth Generation (4G) Long Term Evolution (LTE) RAT.

11. The user device of claim 9, wherein the URSP rule is only applicable to the one or more PLMNs.

12. The user device of claim 9, wherein the URSP rule includes a traffic descriptor and a route selection descriptor, and the RAT is indicated in one or more of the traffic descriptor or the route selection descriptor.

13. The user device of claim 9, wherein the URSP rule includes a traffic descriptor and a route selection descriptor, and the one or more PLMNs are indicated in one or more of the traffic descriptor or the route selection descriptor.

14. The user device of claim 9, wherein the one or more processors, to select the URSP rule, are configured to:
select the URSP rule based on a RAT associated with the UE corresponding to the RAT associated with the URSP rule.

15. The user device of claim 9, wherein the one or more processors, to select the URSP rule, are configured to:
select the URSP rule based on a PLMN associated with the UE corresponding to the one or more PLMNs associated with the URSP rule.

16. A non-transitory computer-readable medium storing a set of instructions, the set of instructions comprising:
one or more instructions that, when executed by one or more processors of a device, cause the device to:
receive, from a network node, a user equipment (UE) route selection policy (URSP) that includes one or more URSP rules, wherein a URSP rule, of the one or more URSP rules, indicates one or more of:
a radio access technology (RAT) associated with the URSP rule, or
one or more public land mobile networks (PLMNs) associated with the URSP rule;
select the URSP rule; and
perform a traffic routing based on the URSP rule.

17. The non-transitory computer-readable medium of claim 16, wherein:
the URSP rule is only applicable to the RAT, and the RAT is a Fourth Generation (4G) Long Term Evolution (LTE) RAT; or
the URSP rule is only applicable to the one or more PLMNs.

18. The non-transitory computer-readable medium of claim 16, wherein:
the URSP rule includes a traffic descriptor and a route selection descriptor, and
the RAT is indicated in one or more of the traffic descriptor or the route selection descriptor, or the one or more PLMNs are indicated in one or more of the traffic descriptor or the route selection descriptor.

19. The non-transitory computer-readable medium of claim 16, wherein the one or more instructions, that cause the device to select the URSP rule, cause the device to:
select the URSP rule based on a RAT associated with the UE corresponding to the RAT associated with the URSP rule; or
select the URSP rule based on a PLMN associated with the UE corresponding to the one or more PLMNs associated with the URSP rule.

20. The non-transitory computer-readable medium of claim 16, wherein the one or more instructions, when executed by the one or more processors, further cause the device to:
select a different URSP rule based on a PLMN associated with the UE not corresponding to the one or more PLMNs associated with the URSP rule.
